(19) United States
(12) Patent Application Publication
(10) Pub. No.: US 2019/0242533 A1
(43) Pub. Date: Aug. 8, 2019

(54) Controllable Lumen Output Light Bulb

(71) Applicant: James J. Smith, El Paso, TX (US)

(72) Inventor: James J. Smith, El Paso, TX (US)

(21) Appl. No.: 15/453,096

(22) Filed: Mar. 8, 2017

(51) Int. Cl. F21K 9/238; H05B 33/08; F21K 9/232

(52) U.S. Cl. CPC F21K 9/238; H05B 33/0845; F21K 9/232; H05B 33/0821

(57) ABSTRACT

The controllable lumen output light bulb includes a plurality of LED elements within a larger element. A switch disposed on the neck provides for using one, two, and three elements by choice, with basic circuitry controlling which elements are utilized in providing a dim light, a medium lumen light, a high light luminescence choice, and a combination of lumen choices. As an example, the elements provide a 40-watt equivalent choice, a 60-watt equivalent choice, and a 100-watt equivalent choice. Offerings are not limited to these particular choices.

### CROSS-REFERENCE TO RELATED APPLICATIONS

Not Applicable

### FEDERALLY SPONSORED RESEARCH OR DEVELOPMENT

Not Applicable

### INCORPORATION BY REFERENCE OF MATERIAL SUBMITTED ON A COMPACT DISK

Not Applicable

### BACKGROUND OF THE INVENTION

A notable deficiency is present in light fixtures, particularly in single bulb lamps. ii Even those fixtures with a well-known rheostat leave many users unsatisfied with the level of luminosity offered. Various types of controllable lumen output light bulbs are known in the prior art, with most offering varied voltage delivery to incandescent bulbs. Any attempt to build a switch within an incandescent bulb has been fruitless, due in part to the size, heat, cost, and impracticality of three incandescent bulbs within one vacuum housing. The controllable lumen output light bulb is thus needed to solve these problems, as well as a host of others, so that users can enjoy economical bright and dim light from the same lamps and fixtures through dependable light emitting diodes, basic circuitry, and immediately recognizable controls. Moreover, the light bulb is low in heat production and cost, and does not require the incorporation of a rheostat or any other overly complex device.

### FIELD OF THE INVENTION

The present controllable lumen output light bulb relates to light bulbs, and more particularly, to an LED light bulb having a switch for choosing different LED elements within the bulb, either individually or in combination.

### SUMMARY OF THE INVENTION

The general purpose of the controllable lumen output light bulb, described subsequently in greater detail, is to provide a controllable lumen output light bulb that has many novel features that result in a controllable lumen output light bulb that is not anticipated, rendered obvious, suggested, or even implied by prior art, either alone or in combination thereof.

To accomplish this, the controllable lumen output light bulb includes a plurality of light emitting diodes. Since power supplies can deviate, the bulb further includes an adapter fitted to an existing bulb power supply. A neck rises from the adapter, with the neck having an interior and an exterior. The neck is a flared neck when possible and otherwise suited to the provided supply. An output segment is affixed to the neck.

The controllable lumen output light bulb further includes each of a low 40-watt LED element, a medium 60-watt LED element, and a high 100-watt LED element disposed within the bulb. The bulb can also be provided in other wattage equivalent element choices based upon the preferences of a user. A multi-positon switch is disposed on the exterior. The multi-position switch is in communication with the low LED element, the medium LED element, and the high LED element. The multi-position switch is also provided to light any combination of elements, as LED operation has been proven to generate far less heat than an incandescent bulb. A variance of this design would be to substitute the multi-position switch with a potentiometer or rheostat and using a dimmable led element to provide a highly adjustable range of lumen output from 0 to max.

A circuitry is disposed within the bulb. The circuitry is in communication with the adapter, the multi-position switch, the low 40-watt equivalent LED element, the medium 60-watt equivalent LED element, and the high 100-watt equivalent LED element. A user selectively positions the switch to choose a lighting of the low 40-watt equivalent element, the medium 60-watt equivalent element, and the high 100-watt equivalent element. The user also, as noted above, can choose to operate a combination of elements at once with a differing multi-position switch.

Thus has been broadly outlined the more important features of the present controllable lumen output light bulb so that the detailed description thereof that follows may be better understood and in order that the present contribution to the art may be better appreciated.

### BRIEF DESCRIPTION OF THE DRAWINGS

### FIGURES

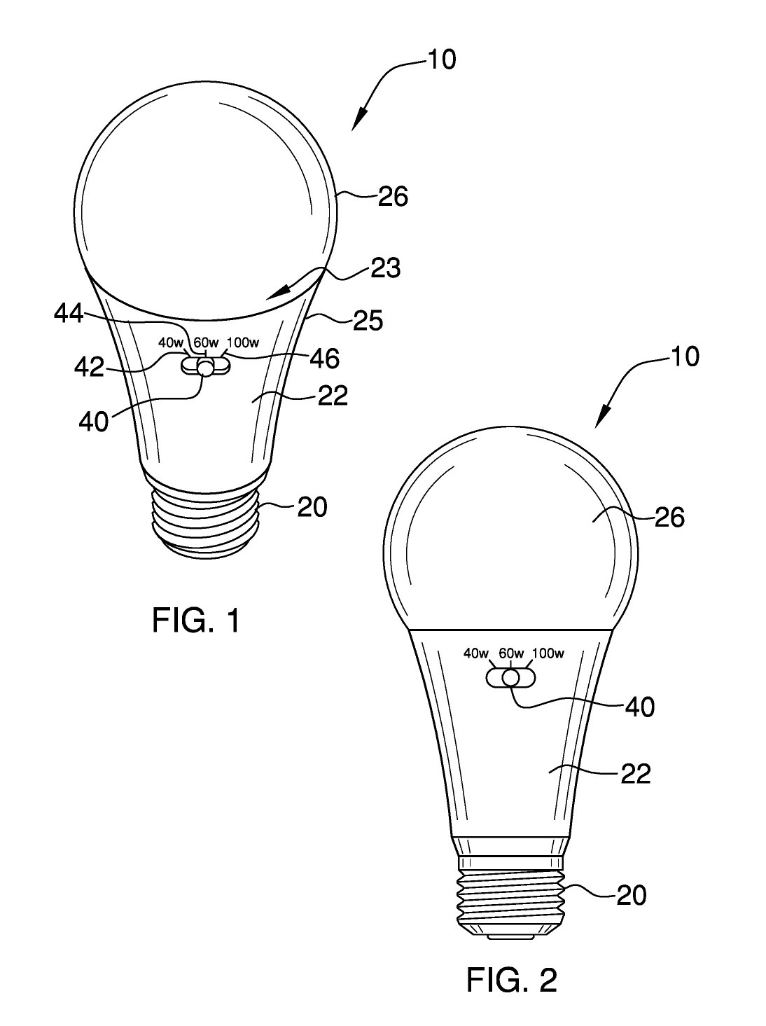

FIG. 1 is a perspective view.

FIG. 2 is a lateral elevation view.

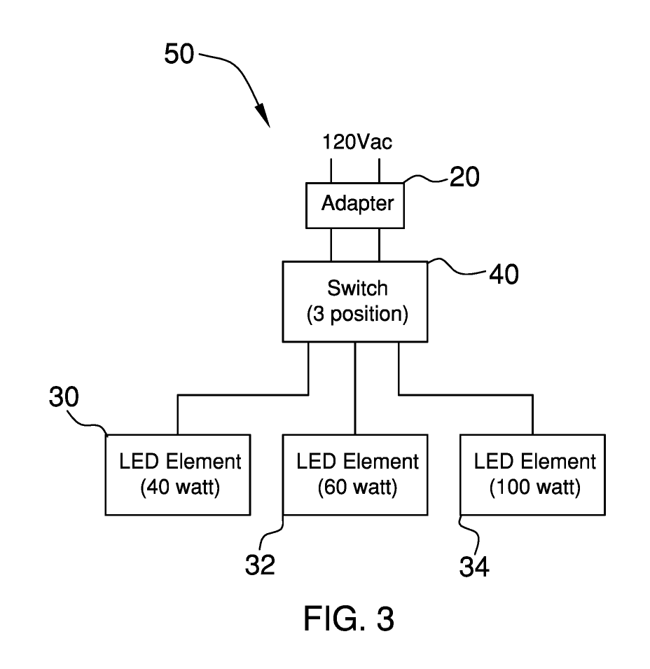

FIG. 3 is a block diagram of circuitry.

### DETAILED DESCRIPTION OF THE DRAWINGS

With reference now to the drawings, and in particular FIGS. 1 through 3 thereof, an example of the controllable lumen output light bulb employing the principles and concepts of the present controllable lumen output light bulb and generally designated by the reference number 10 will be described.

Referring to FIGS. 1 through 3, the controllable lumen output light bulb 10 partially includes an adapter 20 for fitment to an existing power supply. A flared neck 22 arises from the adapter 20. The neck 22 has an interior 23 and an exterior 25. An output segment 26 is affixed to the neck 22. Each of a low 40-watt equivalent LED element 30, a medium 60-watt equivalent LED element 32, and a high 100-watt equivalent LED element 34 is disposed within the bulb 10 as far into the neck 22 as is physically allowed. The elements 30, 32, 34 radiate a light out the output segment 26

The bulb 10 also includes a multi-positon switch 40 disposed on the exterior 25. The multi-position switch 40 is in communication with the adapter 20, the low watt equivalent LED element 30, the medium watt equivalent LED element 32, and the high watt equivalent LED element 34. A circuitry 50 is disposed within the bulb 10. The circuitry 50 is in communication with the adapter 20, the multi-position switch 40, the low 40-watt equivalent LED element 30, the medium 60-watt equivalent LED element 32, and the high 100-watt equivalent LED element 34.

The bulb 10 provides for a user to selectively position the multi-position switch 40 to choose a lighting of the low 40-watt equivalent LED element 30, the medium 60-watt equivalent LED element 32, and the high 100-watt equivalent LED element 34.

1. A controllable lumen output light bulb comprising:
an adapter fitted to an existing power supply;
a flared neck arising from the adapter, the neck having an interior and an exterior;
an output segment affixed to the neck;
each of a low 40-watt equivalent LED element, a medium 60-watt equivalent LED element, and a high 100-watt equivalent LED element disposed within the bulb, wherein each of the low 40-watt equivalent LED element, the medium 60-watt equivalent LED element, and the high 100-watt equivalent LED element radiates a light outwardly from the output segment;
a multi-positon switch disposed on the exterior, the multi-position switch in communication with each of the low LED element, the medium LED element, and the high LED element; and
a circuitry disposed within the bulb, the circuitry in communication with the adapter, the multi-position switch, the low 40-watt equivalent LED element, the medium 60-watt equivalent LED element, and the high 100-watt equivalent LED element;
wherein a user selectively positions the switch to individually choose a lighting of the low 40-watt equivalent LED element, the medium 60-watt equivalent LED element, and the high 100-watt equivalent LED element.

2. A controllable lumen output light bulb comprising:
an adapter fitted to an existing power supply;
a flared neck arising from the adapter, the neck having an interior and an exterior;
an output segment affixed to the neck;
each of a low 40-watt equivalent LED element, a medium 60-watt equivalent LED element, and a high 100-watt equivalent LED element disposed within the bulb, wherein each of the low 40-watt equivalent LED element, the medium 60-watt equivalent LED element, and the high 100-watt equivalent LED element radiates a light outwardly from the output segment;
a multi-positon switch disposed on the exterior, the multi-position switch in communication with the low 40-watt equivalent LED element, the medium 60-watt equivalent LED element, and the high 100-watt equivalent LED element; and
a circuitry disposed within the bulb, the circuitry in communication with the adapter, the multi-position switch, the low 40-watt equivalent LED element, the medium 60-watt equivalent LED element, and the high 100-watt equivalent LED element;
wherein a user selectively positions the switch to choose one of a lighting of the low 40-watt equivalent element, the medium 60-watt equivalent element, and the high 100-watt equivalent element.

3. A controllable lumen output light bulb comprising:
an adapter fitted to an existing power supply;
a neck arising from the adapter, the neck having an interior and an exterior;
an output segment affixed to the neck;
each of a low 40-watt equivalent LED element, a medium equivalent 60-watt LED element, and a high 100-watt equivalent LED element disposed within the bulb, wherein each of the low 40-watt equivalent LED element, the medium 60-watt equivalent LED element, and the high 100-watt equivalent LED element radiates a light outwardly from the output segment;
a multi-positon switch disposed on the exterior, the multi-position switch in communication with the low 40-watt equivalent LED element, the medium 60-watt equivalent LED element, and the high 100-watt equivalent LED element; and
a circuitry disposed within the bulb, the circuitry in communication with the adapter, the multi-position switch, the low 40-watt equivalent LED element, the medium 60-watt equivalent LED element, and the high 100-watt equivalent LED element;
wherein a user selectively positions the switch to choose one of a lighting of the low 40-watt equivalent LED element, the medium 60-watt equivalent LED element, and the high 100-watt equivalent LED element.
